(19) United States
(12) Patent Application Publication
(10) Pub. No.: US 2026/0159649 A1
(43) Pub. Date: Jun. 11, 2026

(54) LINEAR SILICONE - POLYETHER COPOLYMER AND PROCESSES FOR PREPARATION AND USE OF THE COPOLYMER

(71) Applicant: Dow Silicones Corporation, Midland, MI (US)

(72) Inventors: Melissa Aplan, Midland, MI (US); Brian Deeth, Midland, MI (US); Jacqueline L'hostis, Silly (BE); Hatice Turgut, Seneffe (BE)

(21) Appl. No.: 19/127,256

(22) PCT Filed: Jan. 19, 2024
(86) PCT No.: PCT/US2024/012085

§ 371 Date: May 5, 2025

Related U.S. Application Data
(60) Provisional application No. 63/443,733, filed on Feb. 7, 2023.

(51) Int. Cl. C08G 77/46; C08G 77/08; C11D 3/00; C11D 3/37

(52) U.S. Cl. CPC C08G 77/46; C08G 77/08; C11D 3/0026; C11D 3/373

(57) ABSTRACT

A two-step hydrosilylation reaction process for preparing a linear silicone-polyether copolymer is provided. Both steps may be performed in the same reactor. The resulting silicone-polyether copolymer is useful as an antifoam, particularly in a transparent liquid laundry detergent.

### CROSS REFERENCE TO RELATED APPLICATIONS

This application claims the benefit of U.S. Provisional patent application Ser. No. 63/443,733 filed on 7 Feb. 2023 under 35 U.S.C. § 119 (e). U.S. Provisional patent application Ser. No. 63/443,733 is hereby incorporated by reference.

### FIELD

This invention relates to a linear silicone-polyether copolymer, process for preparation of the copolymer, and use of the copolymer as an antifoam. More particularly, the linear silicone-polyether copolymer can be used as an antifoam in a transparent liquid laundry detergent.

### INTRODUCTION

Liquid laundry detergents require antifoams to prevent over-foaming during use in a laundry wash cycle. Transparency of the liquid laundry detergents is a property valued by customers. Existing antifoam technology suffers from the drawback of requiring an expensive stabilization system that reduces transparency of liquid laundry detergents. PCT Patent Publication WO2020/263379A1 discloses a silicone polyether block copolymer that can be used as a foam control agent in liquid laundry detergent.

When a silicone polyether block copolymer is used as a foam control agent in a liquid laundry detergent, increasing the degree of polymerization (DP) of the silicone block can improve antifoam performance to prevent over-foaming. However, increasing DP of the silicone block can also reduce transparency of the liquid laundry detergent. There is an industry need for an antifoam with both good foam control properties and good transparency in a liquid laundry detergent.

### SUMMARY

A silicone-polyether block copolymer and process for its preparation are provided. The silicone-polyether block copolymer is useful as an antifoam in a transparent liquid laundry detergent, and the silicone-polyether block copolymer can provide foam control properties while maintaining transparency in the transparent liquid laundry detergent.

### DETAILED DESCRIPTION

The silicone-polyether block copolymer introduced above can be prepared by the process comprising:
1) combining, under conditions to effect hydrosilylation reaction, starting materials comprising
   I) an aliphatically unsaturated diorganosiloxane of formula:

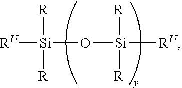

where each R^{U} is an independently selected aliphatically unsaturated monovalent hydrocarbon group, each R is independently selected from the group consisting of a monovalent hydrocarbon group free of aliphatic unsaturation and a monovalent halogenated hydrocarbon group free of aliphatic unsaturation, and each subscript y independently has a value of 1 to 99;
II) an organohydrogensiloxane of formula:

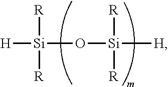

where each R is as described above, and each subscript m independently has a value of 1 to 65;
wherein I) the aliphatically unsaturated diorganosiloxane and II) the organohydrogensiloxane are present in a molar ratio sufficient to provide a silicon bonded hydrogen content/aliphatically unsaturated monovalent hydrocarbon group content (SiH/Vi ratio)>1; and
III) a hydrosilylation reaction catalyst, in an amount sufficient to catalyze hydrosilylation reaction of the silicon bonded hydrogen atoms from II) the organohydrogensiloxane and the aliphatically unsaturated monovalent hydrocarbon groups from I) the aliphatically unsaturated diorganosiloxane;
thereby producing a (first) hydrosilylation reaction product comprising a copolymer of formula (1)

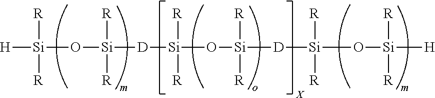

where each D is an independently selected divalent hydrocarbon group, each R is an independently selected monovalent hydrocarbon group free of aliphatic unsaturation, each subscript m independently has a value of 1 to 65, each subscript o independently has a value of 1 to 99, and subscript x is an odd number with a value ≥3, with the proviso that subscripts x, m, and o have values such that the copolymer has ≤200 silicon atoms per molecule; and
2) combining, under conditions to effect hydrosilylation reaction, starting materials comprising:
   A) a polyether of formula

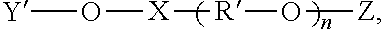

where Y′ is an aliphatically unsaturated organic group, X is selected from a linking bond or a divalent hydrocarbon group having from 2 to 22 carbon atoms, each R′ is an independently selected divalent hydrocarbon group having from 2 to 6 carbon atoms, Z is selected from hydrogen and a monovalent hydrocarbon group having from 1 to 30 carbon atoms, and each subscript n independently has a value of 2 to 60;
B) the copolymer prepared in step 1), described above, optionally C) an additional aliphatically unsaturated compound;
thereby preparing a (second) reaction product comprising a silicone-polyether copolymer mixture.

Step 1) of the process described herein is performed under conditions to effect hydrosilylation reaction of starting materials I) and II), described above. Step 1) may be performed by any convenient means, such as mixing and heating in a reactor. The reactor may be, for example, a batch kettle equipped with mixing means, such as an impeller, and heating and cooling means, such as a jacket. Steps 1) and 2) of the process described herein may be performed in the same reactor. For example, step 1) may be performed, and then once the copolymer of formula (1) forms, step 2) may be carried out by adding other starting materials to the reactor, as described below. Steps 1) and 2) may be performed with heating, e.g., at 30° C. to 125° C., alternatively at least 40° C., alternatively at least 50° C., and alternatively at least 60° C., while at the same time steps 1) and 2) may be performed at a temperature up to 120° C., up to 110° C., up to 150° C., alternatively up to 100° C., alternatively up to 80° C., and alternatively up to 60° C. Alternatively, steps 1) and 2) may be performed with heating at 30° C. to 150° C. Pressure is not critical, and steps 1) and 2) may performed at ambient pressure or under vacuum, i.e., steps 1) and 2) may be performed at 0 mmHg (0 kPa) to 760 mmHg (101.325 kPa). Reaction times for steps 1) and 2) depend on various factors including the species of each starting material and the temperature selected, however, reaction time for step 1) may be 5 minutes to 5 hours, alternatively 2 to 3 hours, when the reaction is run in a batch mode. Alternatively, in step 1), starting materials comprising I) the aliphatically unsaturated organosiloxane and III) the hydrosilylation reaction catalyst may be combined and heated before adding starting material II) the organohydrogensiloxane, which may be added continuously or intermittently in one or more aliquots. The conditions such as temperature and reaction time selected for step 1) may be the same as, or different from, the conditions selected for step 2).

The process described herein can be carried out in one reactor, e.g., steps 1) and 2) may be performed in the same reactor. Alternatively, steps 1) and 2) may be performed in different reactors. The process may optionally comprise one or more additional steps. For example, the process may further comprise a purification step, such as stripping or distillation, optionally under reduced pressure, either after step 1), after step 2), or both. Alternatively, steps 1) and 2) may be performed consecutively, i.e., step 2) may be performed after step 1) without an intermediate purification step. Without wishing to be bound by theory, it is thought that one of the benefits of the present process is that an intermediate purification step (between steps 1) and 2) is unnecessary and may be omitted). Alternatively, the process may further comprise step 3): removing residual catalyst after step 2). Removing residual catalyst may be performed by any convenient means such as described above for the purification step or by filtration. The process may optionally further comprise an additional step after step 1) in which additional hydrosilylation reaction catalyst is added to the reactor before and/or during step 2). The additional hydrosilylation reaction catalyst may be an additional amount of the same species of hydrosilylation reaction catalyst used in step 1) or a different species of hydrosilylation reaction catalyst may be selected.

The starting materials introduced above will be described in detail, below.

### I) Aliphatically Unsaturated Diorganosiloxane

Starting material I) used in the process described herein is the aliphatically unsaturated diorganosiloxane, which may comprise, or may be, a polydiorganosiloxane. The aliphatically unsaturated diorganosiloxane has formula (I-1):

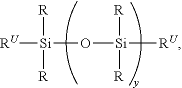

where each R^{U} is an independently selected aliphatically unsaturated monovalent hydrocarbon group, each R is an independently selected monovalent hydrocarbon group free of aliphatic unsaturation, and each subscript y independently has a value of 1 to 99.

In formula (I-1), each R^{U} may be the same or different. Each R^{U} is an aliphatically unsaturated monovalent hydrocarbon group capable of undergoing hydrosilylation reaction with a silicon bonded hydrogen atom of starting material II) the polyorganohydrogensiloxane. Suitable aliphatically unsaturated monovalent hydrocarbon groups include alkenyl groups and alkynyl groups. The aliphatically unsaturated monovalent hydrocarbon groups may have 2 to 18 carbon atoms, alternatively 2 to 12 carbon atoms, alternatively 2 to 10 carbon atoms, alternatively 2 to 8 carbon atoms, and alternatively 2 to 6 carbon atoms. Alternatively, the alkenyl groups may be selected from the group consisting of vinyl, allyl, and hexenyl; alternatively vinyl and allyl; alternatively vinyl and hexenyl. Alternatively, the alkynyl groups may be selected from ethynyl and propynyl. Alternatively, each R^{U} may be an alkenyl group. Alternatively, each R^{U} may be a vinyl group. Alternatively, each R^{U} may be an allyl group. Alternatively, each R^{U} may be a hexenyl group.

In formula (I-1), each R may be the same or different. Each R is independently selected from the group consisting of monovalent hydrocarbon groups free of aliphatic unsaturation and monovalent halogenated hydrocarbon groups free of aliphatic unsaturation. Examples of monovalent hydrocarbon groups for R include, but are not limited to, alkyl such as methyl, ethyl, propyl (including n-propyl and/or isopropyl), butyl (including n-butyl, tert-butyl, sec-butyl, and/or isobutyl); pentyl, hexyl, heptyl, octyl, decyl, dodecyl, undecyl, and octadecyl (and branched isomers having 5 or more carbon atoms); cycloalkyl such as cyclopentyl and cyclohexyl; and aryl such as phenyl, tolyl, xylyl, naphthyl, benzyl, 1-phenylethyl and 2-phenylethyl. Examples of monovalent halogenated hydrocarbon groups for R include, but are not limited to, chlorinated alkyl groups such as chloromethyl and chloropropyl groups; fluorinated alkyl groups such as fluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl; chlorinated cycloalkyl groups such as 2,2-dichlorocyclopropyl, 2,3-dichlorocyclopentyl; and fluorinated cycloalkyl groups such as 2,2-difluorocyclopropyl, 2,3-difluorocyclobutyl, 3,4-difluorocyclohexyl, and 3,4-difluoro-5-methylcycloheptyl. Alternatively, each R may be an alkyl group such as methyl or an aryl group such as phenyl. Alternatively, each R may be methyl.

In formula (I-1), subscript y represents the average number of difunctional siloxane units per molecule. Subscript y has a value of at least 1, alternatively at least 2, alternatively at least 3, alternatively at least 4, alternatively at least 5, alternatively at least 10, alternatively at least 14, alternatively at least 20, alternatively at least 29, and alternatively at least 30; while at the same time, subscript y may have a value up to 99, alternatively up to 49, alternatively up to 46, alternatively up to 45, alternatively up to 40, alternatively up to 35, and alternatively up to 30. Alternatively, subscript y may have a value of 1 to 99, alternatively 1 to 49, alternatively 3 to 49, alternatively 5 to 49, alternatively 5 to 45, and alternatively 29 to 45.

### Starting Material I) is Exemplified by One or More Polydiorganosiloxanes Such as:

i) α,ω-dimethylvinylsiloxy-terminated polydimethylsiloxane,
ii) α,ω-dimethylvinylsiloxy-terminated poly(dimethylsiloxane/methylphenylsiloxane),
iii) α,ω-dimethylvinylsiloxy-terminated poly(dimethylsiloxane/diphenylsiloxane),
iv) α,ω-phenyl,methyl,vinyl-siloxy-terminated polydimethylsiloxane,
v) α,ω-dimethylhexenylsiloxy-terminated polydimethylsiloxane, and
vi) a combination of two or more of i) to v).

Methods of preparing polydiorganosiloxanes suitable for use as starting material I), such as hydrolysis and condensation of the corresponding organohalosilanes and oligomers or equilibration of cyclic polydiorganosiloxanes, are well known in the art, see for example U.S. Pat. Nos. 4,772,515 and 5,317,072, which discloses preparing polydiorganosiloxanes with monovalent hydrocarbon groups with terminal aliphatic unsaturation. Examples of polydiorganosiloxanes having monovalent hydrocarbon groups with terminal aliphatic unsaturation are commercially available from various sources including Dow Silicones Corporation of Midland, Michigan, USA or Gelest, Inc. of Morrisville, Pennsylvania, USA. Starting material I), the aliphatically unsaturated diorganosiloxane, may be one aliphatically unsaturated diorganosiloxane or a combination of two or more aliphatically unsaturated diorganosiloxanes that differ in at least one property such as value of subscript y, selection of R^{U} groups, and/or selection of R groups.

### II) Organohydrogensiloxane

Starting material II) used in the process described herein is the organohydrogensiloxane, which may comprise, or may be, a polyorganohydrogensiloxane. The organohydrogensiloxane has formula (II-1):

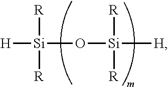

where each R is an independently selected monovalent hydrocarbon group free of aliphatic unsaturation or a monovalent halogenated hydrocarbon groups free of aliphatic unsaturation, and each subscript m independently has a value of 1 to 65. In formula (II-1), each R may be the same or different, and each R is independently selected from the group consisting of monovalent hydrocarbon groups free of aliphatic unsaturation and monovalent halogenated hydrocarbon groups free of aliphatic unsaturation, which are as described above for formula (I-1). In formula (II-1), subscript m represents an average number of siloxane units per molecule. Subscript m has a value of at least 1, alternatively at least 2, alternatively at least 3, alternatively at least 4, alternatively at least 5, and alternatively at least 10; while at the same time, subscript y may have a value up to 65, alternatively up to 49, alternatively up to 45, alternatively up to 40, alternatively up to 35. Alternatively, subscript m may have a value of 1 to 65, alternatively 1 to 49, alternatively 1 to 45, alternatively 1 to 40, alternatively 1 to 35, alternatively 1 to 10, and alternatively 1 to 4.

### Suitable Polyorganohydrogensiloxanes for Use Herein are Exemplified by:

(i) α,ω-dimethylhydrogensiloxy-terminated poly(dimethylsiloxane),
(ii) α,ω-dimethylhydrogensiloxy-terminated poly(dimethyl/methyl,phenyl) siloxane,
(iii) α,ω-dimethylhydrogensiloxy-terminated poly(dimethylsiloxane/diphenyl) siloxane,
(iv) 1,1,3,3-tetramethyldisiloxane,
(v) heptamethyltrisiloxane (e.g., 1,1,1,3,5,5,5-heptamethyltrisiloxane, 1,1,1,3,3,5,5-heptamethyltrisiloxane, or both), and
(vi) a combination of two or more thereof.

Linear polyorganohydrogensiloxanes are also commercially available, such as those available from Dow Silicones Corporation of Midland, Michigan USA or Gelest, Inc. of Morrisville, Pennsylvania, USA. Methods of preparing linear polyorganohydrogensiloxanes suitable for use herein, such as hydrolysis and condensation of organohalosilanes, are well known in the art, as exemplified in U.S. Pat. No. 3,957,713 to Jeram et al. and U.S. Pat. No. 4,329,273 to Hardman, et al. Starting material II), the organohydrogensiloxane, may be one organohydrogensiloxane or a combination of two or more organohydrogensiloxanes that differ in at least one property such as DP and/or selection of R groups.

Starting material I) the aliphatically unsaturated diorganosiloxane, and starting material II) the organohydrogensiloxane, are used in amounts that depend on various factors, however, the amounts are sufficient to provide a hydrosilylation reaction product comprising a copolymer having a silicon bonded hydrogen atom at each end. The amounts of starting materials I) and II) are sufficient to provide a SiH/Vi ratio >1. Alternatively, the amounts may be sufficient to provide a SiH/Vi ratio of >1 to 2, alternatively 1.1 to 2, and alternatively >1 to 1.1.

### III) Hydrosilylation Reaction Catalyst

Starting material III) used in step 1) of the process described herein is a hydrosilylation reaction catalyst. Hydrosilylation reaction catalysts are known in the art and are commercially available. Hydrosilylation reaction catalysts include III-1) platinum group metal catalysts. Such hydrosilylation reaction catalysts can be a metal selected from platinum, rhodium, ruthenium, palladium, osmium, or iridium. Alternatively, the hydrosilylation reaction catalyst may be III-2) a compound of such a metal, for example, chloridotris(triphenylphosphane)rhodium (I) (Wilkinson's Catalyst), a rhodium diphosphine chelate such as [1,2-bis(diphenylphosphino)ethane]dichlorodirhodium or [1,2-bis(diethylphosphino)ethane]dichlorodirhodium, chloroplatinic acid (Speier's Catalyst), chloroplatinic acid hexahydrate, or platinum dichloride; or III-3) a complex of a compound described above with an organopolysiloxane; or III-4) a compound or complex described above microencapsulated in a matrix or coreshell type structure. Complexes of platinum with aliphatically unsaturated organopolysiloxanes include 1,3-diethenyl-1,1,3,3-tetramethyldisiloxane complexes with platinum (Karstedt's Catalyst) and Pt (0) complex in tetramethyltetravinylcyclotetrasiloxane (Ashby's Catalyst). Exemplary hydrosilylation reaction catalysts are described in PCT Patent Publication WO/2021/081822 and the references cited therein. Hydrosilylation reaction catalysts are commercially available, for example, SYL-OFF™ 4000 Catalyst and SYL-OFF™ 2700 are available from Dow Silicones Corporation of Midland, Michigan, USA.

The amount of hydrosilylation reaction catalyst used herein will depend on various factors including the selection of starting materials and their respective contents of silicon bonded hydrogen atoms and aliphatically unsaturated monovalent hydrocarbon groups, and the content of the platinum group metal in the catalyst selected, however, the amount of hydrosilylation reaction catalyst is sufficient to catalyze hydrosilylation reaction of SiH and aliphatically unsaturated monovalent hydrocarbon groups, alternatively the amount of catalyst is sufficient to provide 1 ppm to 6,000 ppm of the platinum group metal based on combined weights of starting materials containing silicon bonded hydrogen atoms and aliphatically unsaturated hydrocarbon groups; alternatively 1 ppm to 1,000 ppm, and alternatively 1 ppm to 100 ppm, on the same basis.

### IV) Solvent

The process described herein may further comprise use of a solvent to aid mixing and/or delivery of one or more of the starting materials, such as the hydrosilylation reaction catalyst. For example, III) the hydrosilylation reaction catalyst may be dissolved and/or dispersed in a solvent, such as a monohydric alcohol exemplified by methanol, ethanol, propanol (e.g., isopropanol) or butanol; an aliphatic hydrocarbon such as hexane or heptane, or an aromatic hydrocarbon such as benzene, toluene, or xylene. Alternatively, the solvent may be omitted, and III) the hydrosilylation reaction catalyst may be dissolved and/or dispersed in an aliphatically unsaturated diorganosiloxane, such as that described above as starting material I).

### V) Additional Starting Material (Optional)

The process described herein may further comprise adding one or more additional starting materials during step 1) or step 2), or both. For example, a process aid may be added, e.g., sodium acetate may optionally be added in step 1). Alternatively, a hydrosilylation reaction catalyst promoter may be added in step 1) and/or step 2).

Step 1) of the process described herein produces a hydrosilylation reaction product comprising a copolymer of formula (1):

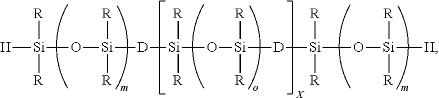

where each D is an independently selected divalent hydrocarbon group, each R is independently selected from the group consisting of monovalent hydrocarbon groups free of aliphatic unsaturation and monovalent halogenated hydrocarbon groups free of aliphatic unsaturation (as described above), each subscript m independently has a value of 1 to 65 (as described above for starting material II), each subscript o independently has a value of 1 to 99, and subscript x has a value ≥3, with the proviso that subscripts x, m, and o have values such that the copolymer has ≤200 silicon atoms per molecule.

In formula (1), divalent hydrocarbon group D forms via the reaction of R^{U} the aliphatically unsaturated monovalent hydrocarbon groups from starting material I) and silicon bonded hydrogen atoms from starting material II). Divalent hydrocarbon group D may have empirical formula (CₐH₂ₐ), where subscript a is 2 to 18. Divalent hydrocarbon group D may be, for example, C₂H₄, C₃H₆, C₄H₈, or C₆H₁₂. Alternatively, when each R^{U} is vinyl, divalent hydrocarbon group D may have empirical formula C₂H₄ and may comprise

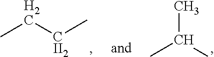

or a combination thereof. Formula (1) has at least 4 instances of D per molecule.

In formula (1), subscript o has a value of 1 to 99. Each instance of subscript o will have a value corresponding to subscript m or subscript y described above. When two or more molecules of I) the aliphatically unsaturated polydiorganosiloxane and three or more molecules of II) the polyorganohydrogensiloxane form the copolymer of formula (1), then at least 2 instances of o=y and at least three instances of o=m. Subscript x in the formula above has a value of at least 3, alternatively at least 5, and alternatively at least 7; while at the same time subscript x may have a value up to 11, alternatively up to 9, alternatively up to 7. Alternatively, subscript x may be 3 to 11, alternatively 3 to 9, and alternatively 5 to 7.

In step 1) of the process described above, I) the aliphatically unsaturated polydiorganosiloxane and II) the polyorganohydrogensiloxane and their amounts are selected such that the copolymer of formula (1) has ≤200 silicon atoms per molecule, alternatively <200 silicon atoms per molecule, alternatively up to 150 silicon atoms per molecule, and alternatively up to 120 silicon atoms per molecule; while at the same time the copolymer of formula (1) may have at least 25 silicon atoms per molecule, alternatively at least 50 silicon atoms per molecule, alternatively at least 60 silicon atoms per molecule, and alternatively at least 80 silicon atoms per molecule. Alternatively, the copolymer of formula (1) may have 80 to 200 silicon atoms per molecule, alternatively 80 to <200 silicon atoms per molecule, and alternatively 80 to 150 silicon atoms per molecule.

### In Step 2) of the Process Described Above, Starting Materials Comprising:

A) the polyether of formula A-1):

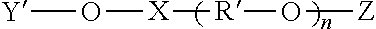

(where Y′, O, X, R′, Z, and subscript n are as described herein),
B) the copolymer prepared in step 1), and
optionally C) an additional aliphatically unsaturated compound (different from A) the polyether),
are combined under conditions to effect hydrosilylation reaction of aliphatically unsaturated groups of starting material A) the polyether (and, when present, starting material C)) and silicon bonded hydrogen atoms of B) the copolymer prepared in step 1). In step 2), optionally III) hydrosilylation reaction catalyst may be added.

### A) Polyether

Starting material A) used in the process described herein is the polyether of formula A-1):

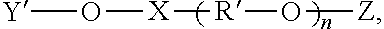

where Y′ is an aliphatically unsaturated monovalent hydrocarbon group, X is selected from a linking bond or a divalent organic group having from 2 to 22 carbon atoms, each R′ is an independently selected divalent hydrocarbon group having from 2 to 6 carbon atoms, Z is selected from hydrogen and a monovalent hydrocarbon group having from 1 to 30 carbon atoms, and subscript n has a value of 2 to 60. Alternatively, Y′ may be an alkenyl group or an alkynyl group, as described and exemplified above for R^{U}. Alternatively, Y′ may be selected from the group consisting of vinyl, allyl, and hexenyl.

In formula A-1), each R′ is an independently selected divalent hydrocarbon group. Divalent hydrocarbon group R′ may have empirical formula (C_{b}H_{2b}), where subscript b is 2 to 6. Divalent hydrocarbon group R′ may be, for example, an alkylene group, such as C₂H₄, C₃H₆, C₄H₈, or C₆H₁₂. Alternatively, the divalent hydrocarbon group for R′ may comprise ethylene, propylene, or a combination thereof.

In formula A-1), X is a linking bond or a divalent organic group having 2 to 22 carbon atoms. The divalent organic group for X may be a divalent hydrocarbon group with 2 to 18 carbon atoms, alternatively 2 to 6 carbon atoms as described and exemplified above for R′. Alternatively, X may be a different divalent organic group, for example, an alkylene substituted with one or more heteroatoms such as oxygen. Alternatively, X may be the linking bond.

In formula A-1), Z is selected from the group consisting of hydrogen, a monovalent hydrocarbon group having 1 to 30 carbon atoms, a hydrocarbonoxy group such as an alkoxy group having from 1 to 30 carbon atoms, and an acyl group. The monovalent hydrocarbon group may for Z may be a monovalent hydrocarbon group as described and exemplified above for R. Alternatively, the monovalent hydrocarbon group for Z may have 1 to 8 carbon atoms. Alternatively, Z may be an alkoxy group such as methoxy, ethoxy, or propoxy or an aryloxy group such as phenoxy. Alternatively, Z may be methyl, ethyl, or phenyl.

In formula A-1), subscript n represents average number of divalent groups of formula (R′—O) (e.g., hydrocarbylene oxide) groups per molecule. Subscript n is an integer with a value of 2 to 60, alternatively 2 to 30, alternatively 2 to 25, alternatively 2 to 20, alternatively 2 to 15, alternatively 2 to 10, alternatively 2 to 7, and alternatively 7 to 10. Alternatively, subscript n may be an integer with a value of at least 2, alternatively at least 3, alternatively at least 4, alternatively at least 5, alternatively at least 6, and alternatively at least 7; while at the same time, subscript n may have a value of up to 60, alternatively up to 30, alternatively up to 25, alternatively up to 20, alternatively up to 15, alternatively up to 10, and alternatively up to 7.

The polyether of formula A-1) is known in the art and commercially available, for example, as described in PCT Patent Publication WO2020/263379A1 at paragraphs [0019] to [0020]. For example, a polyethylene glycol allyl methyl ether is commercially available from Clariant as AM350. Starting material A) may be one polyether, or a combination of two or more polyethers that differ in at least one property such as selection of each R′, the number of units of formula (R′—O) per molecule, the selection of aliphatically unsaturated hydrocarbon group and/or the selection of Z. For example, starting material A) may comprise a first polyether of formula A-1) and a second polyether of formula A-1), where one or more of variables Y′, X, R′, Z or subscript n differ in the first polyether and the second polyether. For example, when each of Y′, X, R′, and Z are the same, subscript n in the first polyether may be less than subscript n for the second polyether. Alternatively, one or more instances of R′ in the first polyether may differ from one or more instances of R′ in the second polyether. For example, R′ in the first polyether may have 2 carbon atoms, and R′ in the second polyether may have more than two carbon atoms, e.g., 3 to 6 carbon atoms. Without wishing to be bound by theory, it is thought that when variables such as R′ in the first polyether is selected to be more polar than variables such as R′ in the second polyether, the resulting copolymer of formula (ABC), described below, will have improved foam control and transparency properties in a transparent liquid laundry detergent. Alternatively, in addition to starting material A), the polyether, the process may include use of C) an additional aliphatically unsaturated compound that differs from starting material A).

### C) Additional Aliphatically Unsaturated Compound

Starting material C) used in the process described herein is optional. For example, starting material C) may be omitted when two or more different polyethers of formula A-1) are used in the process described herein. Alternatively, starting material C) may be present and may be selected from the group consisting of C1) an aliphatically unsaturated trialkoxysilane, C2) an aliphatically unsaturated hydrocarbon such as alkene of 2 to 18 carbon atoms or an alkenyl-functional aromatic compound with 8 to 18 carbon atoms; and C3) a combination of both C1) and C2).

The aliphatically unsaturated trialkoxysilane that may be used as starting material C1) has formula R¹Si(OR²)₃, where R¹ is an aliphatically unsaturated monovalent hydrocarbon group of 2 to 12 carbon atoms, and each R² is an independently selected alkyl group of 1 to 12 carbon atoms. The aliphatically unsaturated monovalent hydrocarbon group for R¹ may be an alkenyl group, such as vinyl, allyl, or hexenyl; alternatively vinyl or hexenyl; and alternatively vinyl. The alkyl group for R² is exemplified by methyl, ethyl, propyl (including n-propyl and/or isopropyl), butyl (including n-butyl, tert-butyl, sec-butyl, and/or isobutyl); pentyl, hexyl, heptyl, octyl, decyl, dodecyl, undecyl, and octadecyl (and branched isomers having 5 or more carbon atoms). Examples of aliphatically unsaturated trialkoxysilanes include alkenyl-functional trialkoxysilanes such as allyltrimethoxysilane, vinyltrimethoxysilane, vinyltriethoxysilane, vinyltriisopropoxysilane, and vinyltris(methoxyethoxy) silane. All of these alkenyl-functional silanes are commercially available from Gelest Inc. of Morrisville, Pennsylvania, USA. Furthermore, alkenyl-functional silanes may be prepared by known methods, such as those disclosed in U.S. Pat. No. 4,898,961 to Baile, et al.

The alkene that may be used as starting material C2) may be branched, linear, or combinations thereof, for example, ethylene, propylene, butylene, hexylene, or alkenes with 7 to 18 carbon atoms per molecule; and branched isomers thereof. Alternatively the alkene may be cyclic such as cyclopentene, cyclohexene or norbornadiene. Alternatively, the alkene may have 2 to 18, alternatively 3 to 16, alternatively 4 to 14, alternatively 5 to 12, and alternatively 6 to 12, carbon atoms per molecule.

The alkenyl-functional aromatic compound that may be used as starting material C2) may have 8 to 18 carbon atoms per molecule, alternatively 8 to 12 carbon atoms. For example, the alkenyl functional aromatic compound may be styrene, α-methylstyrene, or 2,4-dimethylstyrene, which are commercially available, e.g., from Sigma Aldrich Inc. of St. Louis, Missouri, USA.

The amount of starting material A), and when present starting material C), is sufficient to react the silicon bonded hydrogen atoms of B) the copolymer prepared in step 1) with the aliphatically unsaturated groups of starting material A) (and starting material C), when present). When starting material C) is not present, the amounts of starting materials A) and B) are sufficient to provide a molar ratio of silicon bonded hydrogen atoms of B) the copolymer to aliphatically unsaturated groups of A) the polyether (B/A ratio)>0 to 1, alternatively >0 to <1. Alternatively, when starting material C) is not present, the amount of starting material A) is sufficient to provide a B/A ratio of at least 0.1. Alternatively, when starting material C) is present, then the amounts of starting materials A) and C) combined are sufficient to provide a molar ratio of silicon bonded hydrogen atoms to aliphatically unsaturated groups [B/(A+C) ratio] of up to 1, alternatively >0 to <1. Alternatively, equimolar amounts of starting materials A) and C) may be used.

### Silicone-Polyether Copolymer

The process described above forms a reaction product comprising a silicone-polyether copolymer mixture. The silicone-polyether mixture comprises copolymer species of formulae

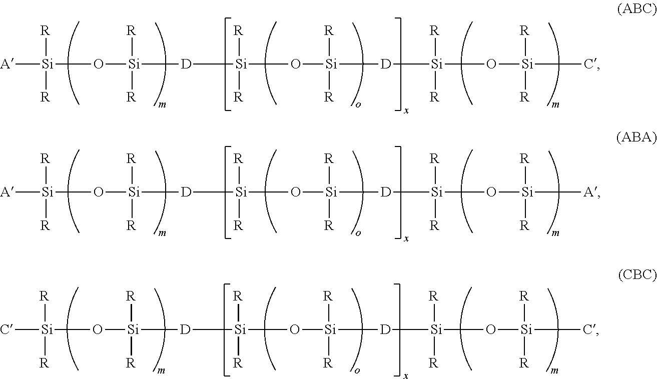

where D and R, and subscripts m, o, and x are as described above. In the formulas above, A′ represents a group derived from starting material A), the polyether of formula A-1). Group A′ has formula

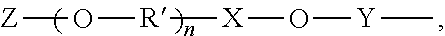

where Y is a divalent hydrocarbon group; and each X is independently selected from the linking bond or the divalent hydrocarbon group having from 2 to 22 carbon atoms, each R′ is the independently selected divalent hydrocarbon group having from 2 to 6 carbon atoms, Z is selected from hydrogen and the monovalent hydrocarbon group having from 1 to 30 carbon atoms, and each subscript n independently has a value of 2 to 60, where X, R′, Z, and subscript n are each as described above for starting material A). In the formula for group A′, group Y is formed from hydrosilylation reaction of aliphatically unsaturated group Y′ (as described above for starting material A)) and a silicon bonded hydrogen atom (from starting material B) the copolymer), and Y is a divalent hydrocarbon group, which may be as described and exemplified above for D in formula (1). Alternatively, R′ in group A′ may have 2 carbon atoms.

In the formulas (ABC), (ABA), and (CBC) for the copolymer mixture above, C′ represents a group that may be derived from starting material C) described above (when starting material C) is present) and/or starting material A), e.g., when more than one polyether of formula A-1) is used in the process. For example, when more two different polyethers of formula A-1) are used in the process described above, A′ and C′ may each have formula

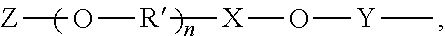

where one or more of the variables Z, R′, X, Y, and subscript n differ between groups A′ and C′. For example, subscript n in group A′ may have a value less than subscript n in group C′. Alternatively, in group A′, R′ may have 2 carbon atoms, and in group C′, R′ may have 3 to 6 carbon atoms when two different polyethers are used.

Alternatively, when C1) the aliphatically unsaturated trialkoxysilane is used in the process described above, C′ may have formula-R³Si(OR²)₃, where R³ is a divalent hydrocarbon group and R² is as described above. Alternatively, when C2) the alkene is used in the process described above, C′ may be an alkyl group, e.g., with empirical formula-C_{c}H_{(2c+1)}, where subscript c has a value of 2 to 12.

Without wishing to be bound by theory, it is thought that the copolymer of formula (ABC) provides the benefit of good antifoam performance and good transparency in a transparent liquid laundry detergent, however, the silicone-polyether copolymer mixture comprising the copolymers of formulas (ABC), (ABA), and (CBC) may be used in the transparent liquid laundry detergent as an antifoam, i.e., it is not necessary to isolate the copolymer of formula (ABC) from the copolymer mixture before using the copolymer in a transparent liquid laundry detergent.

### Method of Use

The silicone-polyether copolymer of formula (ABC) and/or silicone-polyether copolymer mixture comprising copolymers of formulae (ABC), (ABA), and (CBC) prepared as described above are useful as antifoams. These antifoams may be included in various products such as foam control compositions. The antifoam, and the foam control composition containing the antifoam, may provide effective foam control in a liquid laundry detergent, such as a transparent liquid laundry detergent.

Without wishing to be bound by theory, it is thought that the antifoam is “self-emulsifying.” As a consequence, the antifoam can be dispersed and stabilized in a variety of liquids. For example, the antifoam can be utilized by direct addition to a foaming liquid, e.g. a cleaning composition such as a liquid laundry detergent. Alternatively, the antifoam may be combined with one or more additional constituents to form the foam control composition. Representative constituents include linear polydiorganosiloxanes, e.g., trimethyl-siloxy endblocked polydimethylsiloxane (PDMS) available under the trade name DOWSIL™ 200 Fluid from TDCC. When combined with the subject antifoam as part of a foam control formulation, the weight ratio of PDMS to antifoam may be 1:3 to 3:1. Other representative constituents include mineral oils and/or organic solvents. When combined with additional constituents, the combination may be mixed to form an organic liquid mixture. Alternatively, the mixture can be combined with a water dispersible carrier such as silicone glycol or alkyl glycol or mineral oil as described in U.S. Pat. No. 5,908,891. Alternatively, the antifoam may optionally be combined with such constituents along with suitable surface active agent (e.g., fatty acid esters and/or polyalkylene oxides) and optional thickening agents and water under shear to form an oil-in-water emulsion. Methods for preparing such emulsions are known and are described, for example, in U.S. Pat. No. 6,521,586.

Traditionally, foam control compositions have included one or more of: inorganic fillers, cyclic siloxanes and siloxane resins. Common inorganic fillers include finely divided particles of silica. The silica is typically fumed or precipitated. Other inorganic fillers include silicates, zeolites, Al₂O₃, TiO₂, ZrO₂, and combinations thereof. The particles typically have a specific surface area of 50-300 m²/g. Cyclic siloxanes (e.g., D4, D5 and D6) are also commonly present in foam control compositions, but are now regulated in many jurisdictions. Siloxane resins are also commonly used in foam control compositions. See for example U.S. Pat. Nos. 4,145,308; 5,082,590 and 6,207,722. Such resins are commonly referred to as “MQ” resins and comprise predominantly mono-functional (Me₃SiO_{1/2}) and tetra-functional (SiO_{4/2}) units in relative molar ratios of 0.25-0.75 to 1.

Alternatively, the foam control composition of the present invention excludes or minimizes the traditional inclusion of one or more of: inorganic fillers, cyclic siloxanes and siloxane resins. For example, the subject foam control composition may include less than 1 weight %, alternatively less than 0.5 weight %, alternatively less than 0.1 weight %, and alternatively 0 weight % of an inorganic filler. Compositions including less than 0.1 wt % of an inorganic filler are characterized herein as being “substantially free” of inorganic filler.

Alternatively, the foam control composition may include less than 0.5 weight %, alternatively less than 0.1 weight %, alternatively less than 0.01 weight %, and alternatively 0 weight % of cyclic siloxanes. Formulations including less than 0.01 weight % of cyclic siloxane are characterized herein as being “substantially free” of cyclic siloxane. Alternatively, the subject foam control composition may include less than 1 weight %, alternatively less than 0.5 weight %, alternatively less than 0.1 weight %, and alternatively 0 weight % of siloxane resin. Formulations including less than 0.1 weight % of siloxane resin are characterized herein as being “substantially free” of siloxane resin. Alternatively, the foam control composition may be substantially free of one, two or three of the following: inorganic filler, cyclic siloxane and siloxane resin.

The subject foam control agent and formulations thereof may be incorporated into inventive cleaning compositions. Such cleaning compositions may be provided in a variety of forms including but not limited to liquid, gel, paste, bar, granular and powder forms. Such compositions may be used in a variety of cleaning applications including but not limited to laundry, cookware and tableware (including dishware and flatware), hard surfaces along with personal care such as body and hair washing. Alternatively, the cleaning composition may be a liquid laundry detergent composition. Representative liquid laundry detergent formulations include at least one surfactant. Applicable surfactants include: non-ionic (e.g. polysaccharides, oxylates, amine oxides, fatty acid amides), amphoteric, zwitterionic, cationic (alkylammonium salts) and anionic (e.g. sulfonates, polyalkoxylated carboxylates) surfactants. Applicable liquid laundry detergent compositions may optionally include one or more of: soaps (i.e. fatty acid carboxylates), carriers, builders, perfumes, structurants, adjuncts, brighteners, enzymes, dyes, hydrotropes, solvents, dispersants, hueing agents and rheology modifiers. Alternatively, the liquid laundry detergent composition may comprise at least one surfactant and from 0.001 to 4.0 wt. % (alternatively 0.01 to 2.0 wt. %) of the antifoam.

Alternatively, the antifoam may be used in a known liquid laundry detergent composition, such as that disclosed in U.S. Patent Publication 2017/0233681 or PCT Patent Publication WO2020/263379; in addition to, or instead of, the antifoam described therein. Alternatively, the antifoam described herein may be used in addition to, or instead of, the silicone polyether in a cleaning composition such as that described in U.S. Pat. Nos. 3,933,672; 8,492,325; 9,133,421; 10,005,110; U.S. Patent Publication 2017/0218312; or U.S. Patent Publication 2017/0233681.

Alternatively, the antifoam may be used in a transparent liquid laundry detergent composition. For example, the transparent liquid laundry detergent composition may comprise, water, a surfactant such as an anionic surfactant, a nonionic surfactant, or a combination thereof, a stabilizer such as an alkylene glycol (e.g., propylene glycol and/or ethylene glycol from TDCC), and a neutralizer such as an alkanolamine (e.g., triethanolamine), in addition to the antifoam described herein. Suitable anionic surfactants include alkylbenzene sulfonates such as linear C10-C13 alkyl benzene sulfonate sodium salt marketed as DISPONIL™ LDBS 55 from BASF, sodium laureth sulfate such as MARLINAT™ 242/28 from Sasol Chemicals; and combinations thereof. Suitable nonionic surfactants include polyalkylene glycol ethers such as alkyl polyethylene glycol ether made from a C₁₂ to C₁₈ alcohol and ethylene oxide such as DEHYDOL™ LT 7 from BASF. The amount of the antifoam in the transparent liquid laundry detergent composition depends on various factors including the type and amount of the silicone-polyether copolymer of formula (ABC) described above and the type and amount of the other components of the transparent liquid laundry detergent, however, the amount of the antifoam may be at least 0.001 weight %, alternatively at least 0.01 weight %, alternatively at least 0.1 weight %, alternatively at least 0.5 weight %; while at the same time the amount may be up to 4 weight %, alternatively up to 2 weight %, alternatively up to 1 weight %, and alternatively up to 0.5 weight %, each based on weight of the transparent liquid laundry detergent composition.

### Examples

The following examples are provided to illustrate the invention to one skilled in the art and are not to be interpreted as limiting the invention set forth in the claims. Starting materials used herein are described below in Table 1.

TABLE 1
Starting Materials

| Starting Material | Chemical Description | Source |
|---|---|---|
| I-1 | Bis-vinyl terminated | TDCC |
| (ViMe₂SiO_{1/2})₂(Me₂SiO_{2/2})₄₄ | polydimethylsiloxane with DP = 46 | |
| I-2 | Bis-vinyl terminated | TDCC |
| (ViMe₂SiO_{1/2})₂(Me₂SiO_{2/2})₂₈ | polydimethylsiloxane with DP = 30 | |
| II-1 (HMe₂SiO_{1/2})₂ | 1,1,3,3-tetramethyldisiloxane | TDCC |
| II-2 | Bis-hydrido terminated | TDCC |
| (HMe₂SiO_{1/2})₂(Me₂SiO_{2/2})₇₈ | polydimethylsiloxane with DP = 80 | |
| II-3 | Bis-hydrido terminated | TDCC |
| (HMe₂SiO_{1/2})₂(Me₂SiO_{2/2})₉₈ | polydimethylsiloxane with DP = 100 | |
| (HMe₂SiO_{1/2})₂(Me₂SiO_{2/2})₁₉₈ | Bis-hydrido terminated | TDCC |
| | polydimethylsiloxane with DP = 200 | |
| III-1 | Karstedt's catalyst | TDCC |
| A-1 CH₂═CHCH₂(C₂H₄O)₇CH₃ | allyl/methyl terminated polyethylene | Clariant, |
| | oxide with an average of 7 ethylene | Polyglykol AM |
| | oxide units per molecule (DP = 7) | 350 |
| A-1 CH₂═CHCH₂(C₃H₆O)₂CH₃ | Allyl/methyl-terminated polypropylene | Sanyo |
| | oxide with an average of 2 propylene | Chemical |
| | oxide units per molecule (DP = 2) | Industries, Ltd. |
| | | SANYCOL M- |
| | | 0002 |
| IV-1 IPA | isopropanol | |
| Anionic Surfactant 1 | Disponil 55 | BASF |
| Anionic Surfactant 2 | Marlinat 248/28 | Sasol |
| | | Chemicals |
| Nonionic Surfactant 1 | Dehydol LT7 | BASF |
| Polypropylene glycol | | The Dow |
| | | Chemical |
| | | Company |
| N(OEt)₃ | Triethanolamine | Aldrich |
| Water | | |
| Anionic Surfactant | Linear C₁₀-C₁₃ alkylbenzene sulfonate, | BASF |
| DISPONIL ™ LDBS 55 | sodium salt | |

Example 1: A 2-liter jacketed glass reactor equipped with a heating unit, mechanical agitator, nitrogen purge, and condenser was charged with 719.3 g bis-vinyl terminated polydimethylsiloxane DP=46. Reactor contents were heated to 30° C. while mixing. 48.1 g 1,1,3,3-tetramethyldisiloxane was added to the reactor. 2 ppm Karstedt's catalyst diluted in bis-vinyl terminated polydimethylsiloxane DP=46 was added. The reaction was allowed to exotherm and then held at 40° C. for 2 hr. A sample was taken and measured for SiH content using FTIR (SiH=350 ppm). The reactor was then charged with 35.1 g allyl/methyl terminated polypropylene oxide DP=2, and 63.8 g allyl/methyl terminated polyethylene oxide DP=7 and heated to 105° C. 8 ppm Karstedt's catalyst in IPA was added. The reactor was held at 105° C. for 2 hours before cooling. SiH content was not detected by FTIR.

Example 2: A 250 mL round bottom flask equipped with a heating mantle, magnetic stir bar, nitrogen purge, and condenser was charged with 41.3 g bis-vinyl terminated polydimethylsiloxane DP=30 and 3.6 g 1,1,3,3-tetramethyldisiloxane. 4 ppm Karstedt's catalyst diluted in bis-vinyl terminated polydimethylsiloxane DP=30 was added. The mixture was heated to 40° C. and held for 3 hours. The reactor was then charged with 1.7 g allyl/methyl terminated polypropylene oxide DP=2, and 3.0 g allyl/methyl terminated polyethylene oxide DP=7 and heated to 100° C. 4 ppm Karstedt's catalyst in IPA was added. The reactor was held at 100° C. for 3 hours before cooling. SiH content was measured <5 ppm by NMR.

Example 3: A 2-liter jacketed glass reactor equipped with a heating unit, mechanical agitator, nitrogen purge, and condenser was charged with 747.2 g bis-vinyl terminated polydimethylsiloxane DP=46. Reactor contents were heated to 30° C. while mixing. 44.0 g 1,1,3,3-tetramethyldisiloxane was added to the reactor. 2 ppm Karstedt's catalyst diluted in bis-vinyl terminated polydimethylsiloxane DP=46 was added. The reaction was allowed to exotherm and then held at 40° C. for 2 hr. A sample was taken and measured for SiH content using FTIR (SiH=280 ppm). The reactor was then charged with 26.5 g allyl/methyl terminated polypropylene oxide DP=2, and 47.9 g allyl/methyl terminated polyethylene oxide DP=7 and heated to 105° C. 8 ppm Karstedt's catalyst in IPA was added. The reactor was held at 105° C. for 2 hours before cooling. SiH content was not detected by FTIR.

Example 4: A 250 mL round bottom flask equipped with a heating mantle, magnetic stir bar, nitrogen purge, and condenser was charged with 41.5 g bis-vinyl terminated polydimethylsiloxane DP=30 and 3.4 g 1,1,3,3-tetramethyldisiloxane. 4 ppm Karstedt's catalyst diluted in bis-vinyl terminated polydimethylsiloxane DP=30 was added. The mixture was heated to 40° C. and held for 3 hours. The reactor was then charged with 1.7 g allyl/methyl terminated polypropylene oxide DP=2, and 3.0 g allyl/methyl terminated polyethylene oxide DP=7 and heated to 100° C. 4 ppm Karstedt's catalyst in IPA was added. The reactor was held at 100° C. for 3 hours before cooling. SiH content was measured <5 ppm by NMR.

Comparative Example 5 (DP>200): A 250 mL round bottom flask equipped with a heating mantle, magnetic stir bar, nitrogen purge, and condenser was charged with 44.6 g bis-vinyl terminated polydimethylsiloxane DP=30 and 3.2 g 1,1,3,3-tetramethyldisiloxane. 4 ppm Karstedt's catalyst diluted in bis-vinyl terminated polydimethylsiloxane DP=30 was added. The mixture was heated to 40° C. and held for 3 hours. The reactor was then charged with 1.7 g allyl/methyl terminated polypropylene oxide DP=2, and 3.0 g allyl/methyl terminated polyethylene oxide DP=7 and heated to 100° C. 4 ppm Karstedt's catalyst in IPA was added. The reactor was held at 100° C. for 3 hours before cooling. SiH content was measured <5 ppm by NMR.

Comparative Example 6—(equilibration) Comparison with Example #1, 2: A 100 mL round bottom flask equipped with a heating mantle, magnetic stir bar, nitrogen purge, and condenser was charged with 30 g bis-hydrido terminated polydimethylsiloxane DP=80 and 1.1 g allyl/methyl terminated polypropylene oxide DP=2. Reactor contents were mixed at room temperature until a homogenous mixture was obtained. The reactor was heated to 85° C. 3 ppm, and Karstedt's catalyst in IPA was added. The reactor was held at 85° C. for 5 hours before cooling to ambient temperature. 3.19 g allyl/methyl terminated polyethylene oxide DP=7 and 1 mL IPA were added to the flask. The reactor was heated to 85° C. 4 ppm Karstedt's catalyst in IPA was added. The reactor was held at 85° C. for 7 hours. IPA was removed by distillation before cooling to RT. SiH content was measured <5 ppm by NMR.

Comparative Example 7 (equilibration): (Comparison with Example #3, 4): A 2-liter jacketed glass reactor equipped with a heating unit, mechanical agitator, nitrogen purge, and condenser was charged with 776 g bis-hydrido terminated siloxane DP=100, 26 g allyl/methyl terminated polypropylene oxide DP=2, and 47 g allyl/methyl terminated polyethylene oxide DP=7. The system was purged with nitrogen and reactor contents heated to 105° C. while mixing. 8 ppm Karstedt's catalyst in IPA was added. The reactor was held at 105° C. for 2 hours before cooling. SiH content was not detected by FTIR.

Comparative Example 8 (equilibration): (Comparison with Example 5): A 250 mL round bottom flask equipped with a heating mantle, magnetic stir bar, nitrogen purge, and condenser was charged with 45 g bis-hydrido terminated polydimethylsiloxane DP=200, 0.7 g allyl/methyl terminated polypropylene oxide DP=2, and 1.3 g allyl/methyl terminated polyethylene oxide DP=7. Reactor contents were mixed at room temperature until a homogenous mixture was obtained. The reactor was heated to 90° C. 6 ppm Karstedt's catalyst in IPA was added. The reactor was held at 90° C. for 3 hours before cooling. SiH content was measured <5 ppm by NMR.

To demonstrate the impact of various SPEs on foaming, several samples of cleaning compositions were prepared by mixing various SPEs prepared as described in the examples above as foam control agents into a model cleaning composition (liquid detergent) using a Hauschild Speedmixer. The constituents of the cleaning composition are listed below in Table 2. The foam control performance for each sample of cleaning composition was measured by adding 0.7 g of the cleaning composition (including a SPE prepared as described in the examples above as foam control agent) to 300 ml of tap water in a graduated cylinder. The cylinder was then rotated for 9 minutes making 30 revolution per minute after which the foam height was measured.

A summary of the results is provided in Table 3. The transparency of the cleaning compositions was measured using the % of transmittance: the percentage of light transmittance through samples was measured using a Turbiscan™ from Formulaction (www.formulaction.com). A light source (880 nm) was sent to glass tubes containing the cleaning composition containing the SPE. A detector acquired the transmitted signal (T). The higher the transmittance value, the more transparent was the cleaning composition. A summary of the results is included in Table 3.

TABLE 2
Model Liquid Detergent Formulation

| Constituent: | Wt. % |
|---|---|
| SPE (specified below) | 0.5 |
| Anionic surfactant (Disponil 55) | 26 |
| Anionic surfactant (Marlinat 248/28) | 18 |
| Nonionic surfactant (Dehydol LT7) | 12 |
| Propylene Glycol (Dow Chemical | 30 |
| Company) | |
| Triethanolamine (Aldrich) | 5 |
| Water | up to 100 |

TABLE 3
Foaming and Transmittance Test Results

| Example No. | Foam test (cm) | Transmittance % |
|---|---|---|
| Control (No SPE foam control agent) | 24 | 85.07 |
| 1 | 9 | 53.31 |
| 2 | 9 | 75.46 |
| 3 | 6 | 43.38 |
| 4 | 8 | 63.25 |
| Comparative Example 5 | 14 | 45.59 |
| Comparative Example 6 (Comparison with Ex 1, 2) | 9 | 50.65 |
| Comparative Example 7 (Comparison with Ex 3, 4) | 6 | 26.03 |
| Comparative Example 8 (Comparison with Ex 5) | 8 | 22.73 |

The data in Table 3 shows that Examples 1 and 2 have improved transparency without sacrificing foam control performance as compared to Example 6. Example 1 contains a silicone-polyether copolymer with an average of 5.1 ethylene groups (divalent hydrocarbon groups D as shown in formulas ABA, ABC, and CBC) per molecule, and Example 2 contains a silicone-polyether copolymer with an average >5.1 ethylene groups per molecule. Examples 1 and 2 show that increasing the number of divalent hydrocarbon groups, D, can improve transparency when the silicone-polyether copolymer is used in a liquid detergent formulation. Table 3 also shows that Examples 3 and 4, which include an antifoam according to the present invention, have better transparency than Example 7, which contains a comparative silicone polyether made via an equilibration process without the divalent hydrocarbon groups, D, of the antifoam in this invention. Comparative Example 5 shows that using a silicone-polyether copolymer with >200 silicon atoms per molecule results in both poor foam control performance and poor transparency in the liquid laundry detergent tested.

### INDUSTRIAL APPLICABILITY

The above examples show that the silicone-polyether copolymer prepared by the process described herein provides both good foam control and good transparency in a liquid laundry detergent composition. Without wishing to be bound by theory, it is thought that this process also avoids production of cyclic polydiorganosiloxanes, such as D4, D5, and D6, as compared to previous equilibration processes for making silicone polyether copolymers.

### Definitions and Usage of Terms

All amounts, ratios, and percentages herein are by weight, unless otherwise indicated. The SUMMARY and ABSTRACT are hereby incorporated by reference. The articles, “a”, “an”, and “the” each refer to one or more, unless otherwise indicated by the context of the specification. The transitional phrases “comprising”, “consisting essentially of”, and “consisting of” are used as described in the Manual of Patent Examining Procedure Ninth Edition, Revision 08.2017, Last Revised January 2018 at section § 2111.03 I., II., and III. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples. The abbreviations used herein have the definitions in Table 4.

TABLE 4
Abbreviations

| Abbreviation | Definition |
|---|---|
| ° C. | degrees Celsius |
| cm | centimeter |
| D | a difunctional siloxane unit of formula (Me₂SiO_{2/2}) |
| D4 | octamethylcyclotetrasiloxane |
| D5 | decamethylcyclopentasiloxane |
| D6 | dodecamethylcyclohexasiloxane |
| DP | Degree of polymerization |
| ° F. | degrees Fahrenheit |
| FTIR | Fourier Transform Infra Red |
| g | gram |
| h or hr | hour |
| m | meters |
| M | a monofunctional siloxane unit of formula (Me₃SiO_{1/2}) |
| Me | methyl |
| min | minutes |
| mL or ml | milliliters |
| ND | Not determined |
| nm | nanometer |
| NMR | Nuclear magnetic resonance |
| PDMS | polydimethylsiloxane |
| ppm | Parts per million |
| RPM | revolutions per minute |
| RT | room temperature of 25° C. ± 2° C. |
| SPE | silicone polyether |
| TDCC | The Dow Chemical Company of Midland, Michigan, USA |
| uL | microliter |
| um | micrometer |
| Vi | vinyl |

The invention has been described in an illustrative manner, and it is to be understood that the terminology which has been used is intended to be in the nature of words of description rather than of limitation. With respect to any Markush groups relied upon herein for describing particular features or aspects, different, special, and/or unexpected results may be obtained from each member of the respective Markush group independent from all other Markush members. Each member of a Markush group may be relied upon individually and or in combination and provides adequate support for specific embodiments within the scope of the appended claims.

Furthermore, any ranges and subranges relied upon in describing the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and any other subrange subsumed within the range. As just one example, a range of “1 to 99” may be further delineated into a lower third, i.e., 1 to 33, a middle third, i.e., 34 to 66, and an upper third, i.e., from 67 to 99, and alternatively, the range “1 to 99” includes the subranges “1 to 10”, “2 to 49”, and “3 to 46” each which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit.

### Test Methods

The silicon-bonded hydrogen (Si—H) content of polyorganohydrogensiloxanes can be determined using FTIR or NMR, as follows.

### FTIR

Samples were evaluated by FTIR as follows: All samples were diluted to 10% by weight in tetrachloroethylene and loaded into a 0.5 mm path length liquid cell with calcium fluoride windows. Measurements were made on a Perkin Elmer Spectrum 100 FTIR spectrometer, 4000-500 cm-1 with 8 cm-1 resolution.

To quantify SiH content of experimental samples, a calibration curve of absorbance at approximately 2120 cm-1 was generated using samples with known SiH content ranging from 0-825 ppm SiH. This calibration curve was used to quantify SiH content of experimental samples which was used to determine DP.

### NMR

Samples were evaluated by NMR as follows: All samples were dissolved in deuterated chloroform/chromium (III) acetylacetonate and measured by 29Si NMR on a 400 AVANCE III or a 600 AVANCE NEO NMR spectrometer from BRUKER. A 10 mm BB probe was used. The pulse sequence zgig was used. Silicon species were identified based on chemical shift. DP was determined by summing M groups within the siloxane chain (-Me₂Si(O_{1/2})CH₂CH₂Si(O_{1/2})Me₂-) and D groups.

The silicon-bonded hydrogen to alkenyl and/or alkynyl ratio (abbreviated “SiH/Vi ratio”) can be determined by calculating the total weight % of aliphatically unsaturated monovalent hydrocarbon groups in the composition, e.g. vinyl [V] and the total weight % of silicon bonded hydrogen [H] in the composition and given the molecular weight of hydrogen is 1 and of vinyl is 27 the molar ratio of silicon bonded hydrogen to vinyl is 27 [H]/[V].

### Embodiments of the Invention

In a first embodiment, a process for preparing a transparent liquid laundry detergent composition comprises:
1) combining, under conditions to effect a first hydrosilylation reaction, starting materials comprising:
   I) an aliphatically unsaturated diorganosiloxane of formula:

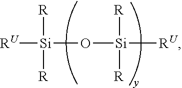

where each R^{U} is an independently selected aliphatically unsaturated monovalent hydrocarbon group, each R is independently selected from the group consisting of monovalent hydrocarbon groups free of aliphatic unsaturation and monovalent halogenated hydrocarbon groups free of aliphatic unsaturation, and each subscript y independently has a value of 1 to 99;
II) an organohydrogensiloxane of formula:

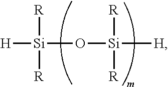

where each R is independently selected from the group consisting of a monovalent hydrocarbon group free of aliphatic unsaturation and a monovalent halogenated hydrocarbon group free of aliphatic unsaturation, and each subscript m independently has a value of 1 to 65;
wherein I) the aliphatically unsaturated polydiorganosiloxane and II) the polyorganohydrogensiloxane are present in a molar ratio sufficient to provide an silicon bonded hydrogen content/aliphatically unsaturated monovalent hydrocarbon group content (SiH/Vi ratio)>1; and
III) a hydrosilylation reaction catalyst, in an amount sufficient to catalyze hydrosilylation reaction of the silicon bonded hydrogen atoms from II) the polyorganohydrogensiloxane and the aliphatically unsaturated monovalent hydrocarbon groups from I) the aliphatically unsaturated polydiorganosiloxane;
thereby producing a first reaction product comprising a copolymer of formula

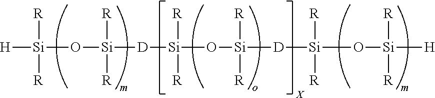

where each D is an independently selected divalent hydrocarbon group, each R is independently selected from the group consisting of a monovalent hydrocarbon group free of aliphatic unsaturation and a monovalent halogenated hydrocarbon group free of aliphatic unsaturation, each subscript m independently has a value of 1 to 65, each subscript o independently has a value of 1 to 99, and subscript x has a value ≥3, with the proviso that subscripts x, m, and o have values such that the copolymer has ≤200 silicon atoms per molecule; and
2) combining, under conditions to effect a second hydrosilylation reaction, starting materials comprising:
   A) a polyether of formula (A-1)

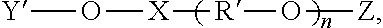

where Y′ is an aliphatically unsaturated organic group, X is selected from a linking bond or a divalent hydrocarbon group having from 2 to 22 carbon atoms, each R′ is an independently selected divalent hydrocarbon group having from 2 to 6 carbon atoms, Z is selected from hydrogen and a monovalent hydrocarbon group having from 1 to 30 carbon atoms, and each subscript n independently has a value of 2 to 60;
B) the copolymer prepared in step 1), described above,
optionally C) an additional aliphatically unsaturated compound selected from the group consisting of C1) a silane, C2) an alkene, and C3) a combination hereof;
with the proviso that C) the additional aliphatically unsaturated compound is present when one polyether of formula A-1) is used as starting material A);
thereby preparing a second reaction product comprising a silicone-polyether copolymer mixture;
optionally 3) combining the silicone-polyether copolymer mixture and at least one additional constituent, thereby forming a foam control composition; and
4) combining the silicone-polyether copolymer mixture or the foam control composition and one or more additional components selected from the group consisting of water, a surfactant, a stabilizer, and a neutralizer, thereby forming the transparent liquid laundry detergent.

In a second embodiment, in the process of the first embodiment, each R is a methyl group, each D has empirical formula (C₂H₄), and subscripts x, m, and o have values such that the copolymer has 80 to 150 silicon atoms per molecule.

In a third embodiment, in the process of the second embodiment, the process further comprises removing residual catalyst from the second reaction product after step 2) and before step 3).

In a fourth embodiment, in the process of any one of the first to third embodiments, in A) the polyether, Y′ is an alkenyl group of 2 to 6 carbon atoms, each R′ is independently ethylene or propylene, X is the linking bond, and Z is hydrogen or an alkyl group of 1 to 8 carbon atoms.

In a fifth embodiment, in the process of any one of the first to fourth embodiments, in step 2) C) the additional aliphatically unsaturated compound is present and is selected from the group consisting of:
C1) an aliphatically unsaturated trialkoxysilane of formula R¹Si(OR²)₃, where R¹ is an aliphatically unsaturated monovalent hydrocarbon group of 2 to 12 carbon atoms, and each R² is an independently selected alkyl group of 1 to 12 carbon atoms;
C2) an aliphatically unsaturated hydrocarbon of 2 to 18 carbon atoms; and
C3) a combination of both C1) and C2).

In a sixth embodiment, in the process of the first embodiment, the silicone-polyether copolymer mixture comprises copolymer species of formulas:

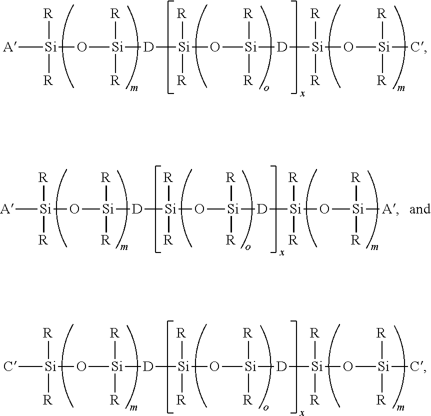

where D and R and subscripts m, o, and x are as described above, A′ is a group derived from the polyether and has formula

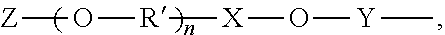

where each X is independently selected from a linking bond or a divalent hydrocarbon having from 2 to 22 carbon atoms, each R′ is independently a divalent hydrocarbon group having from 2 to 6 carbon atoms, Z is selected from hydrogen and a monovalent hydrocarbon group having from 1 to 30 carbon atoms, and each subscript n independently has a value of 2 to 60; and C′ has a formula selected from the group consisting of:
—R³Si(OR²)₃, where R³ is a divalent hydrocarbon group and R² is as described above;
—R⁴, where R⁴ is an alkyl group; and

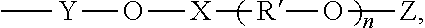

where Z, R′, X, Y, and subscript n are as described above for A′, with the proviso that at least one of Z, R′, X, Y, and subscript n differs from that of A′.

In a seventh embodiment, in the process of the sixth embodiment, each R is a methyl group, each D has empirical formula (C₂H₄), and subscripts x, m, and o have values such that each copolymer in the silicone-polyether copolymer mixture has 80 to 150 silicon atoms per molecule.

In an eighth embodiment, in the process of the sixth embodiment or the seventh embodiment, each Y is an independently selected alkylene group of 2 to 6 carbon atoms, each R′ is independently ethylene or propylene, each X is the linking bond, and each Z is hydrogen or an alkyl group of 1 to 8 carbon atoms.

In a ninth embodiment, in the process of any one of the first to eighth embodiments, step 3) is present, and the additional constituent is selected from the group consisting of a linear polydiorganosiloxane, a mineral oil, an organic solvent, a water dispersible carrier, or a combination thereof.

In a tenth embodiment, in the process of the ninth embodiment, the foam control composition is free of at least one of: cyclic siloxanes, inorganic fillers and siloxane resins.

In an eleventh embodiment, in the process of any one of the first to tenth embodiments, in step 4), the stabilizer is present, and the stabilizer comprises an alkylene glycol.

In a twelfth embodiment, in the process of any one of the first to eleventh embodiments, in step 4), the surfactant is present, and the surfactant is selected from an anionic surfactant, a nonionic surfactant, or a combination thereof.

In a thirteenth embodiment, in the process of any one of the first to twelfth embodiments, the neutralizer is present, and the neutralizer comprises an alkanolamine.

In a fourteenth embodiment, in the process of any one of the sixth to thirteenth embodiments, A′ has formula

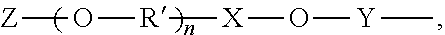

where Z, X, Y, and subscript n are as described above, and R′ has 2 carbon atoms.

In a fifteenth embodiment, in the process of the fourteenth embodiment, C′ has formula

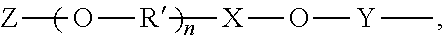

where, X, Y, and subscript n are as described above, and R′ has 3 to 6 carbon atoms.

In a sixteenth embodiment, the process of any one of the first to fifteenth embodiments further comprises forming a foam control formulation by combining starting materials comprising: the copolymer mixture and at least one additional constituent before forming the transparent liquid laundry detergent.

In a seventeenth embodiment, in the process of the sixteenth embodiment, the additional constituent is selected from the group consisting of a linear polydiorganosiloxane, a mineral oil, an organic solvent, a water dispersible carrier, a surface active agent, a thickening agent, water, and combinations thereof.

In an eighteenth embodiment, a transparent liquid laundry detergent is prepared by the process of any one of the first to seventeenth embodiments.

1. A process comprising:
1. combining, under conditions to effect hydrosilylation reaction, starting materials comprising:
I) an aliphatically unsaturated diorganosiloxane of formula: 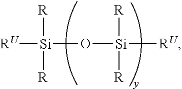
where each R^{U} is an independently selected aliphatically unsaturated monovalent hydrocarbon group, each R is independently selected from the group consisting of monovalent hydrocarbon groups free of aliphatic unsaturation and monovalent halogenated hydrocarbon groups free of aliphatic unsaturation, and each subscript y independently has a value of 1 to 99;
II) an organohydrogensiloxane of formula: 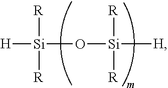
where each R is independently selected from the group consisting of a monovalent hydrocarbon group free of aliphatic unsaturation and a monovalent halogenated hydrocarbon group free of aliphatic unsaturation, and each subscript m independently has a value of 1 to 65;
wherein I) the aliphatically unsaturated polydiorganosiloxane and II) the polyorganohydrogensiloxane are present in a molar ratio sufficient to provide a silicon bonded hydrogen content/aliphatically unsaturated monovalent hydrocarbon group content (SiH/Vi ratio)>1; and
III) a hydrosilylation reaction catalyst, in an amount sufficient to catalyze hydrosilylation reaction of the silicon bonded hydrogen atoms from II) the polyorganohydrogensiloxane and the aliphatically unsaturated monovalent hydrocarbon groups from I) the aliphatically unsaturated polydiorganosiloxane;
thereby producing a first reaction product comprising a copolymer of formula 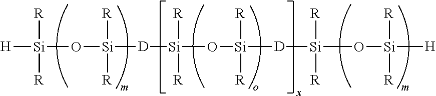
where each D is an independently selected divalent hydrocarbon group, each R is independently selected from the group consisting of a monovalent hydrocarbon group free of aliphatic unsaturation and a monovalent halogenated hydrocarbon group free of aliphatic unsaturation, each subscript m independently has a value of 1 to 65, each subscript o independently has a value of 1 to 99, and subscript x has a value ≥3, with the proviso that subscripts x, m, and o have values such that the copolymer has ≤200 silicon atoms per molecule; and
2. combining, under conditions to effect hydrosilylation reaction, starting materials comprising:
A) a polyether of formula (A-1) 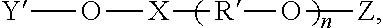
where Y′ is an aliphatically unsaturated organic group, X is selected from a linking bond or a divalent hydrocarbon group having from 2 to 22 carbon atoms, each R′ is an independently selected divalent hydrocarbon group having from 2 to 6 carbon atoms, Z is selected from hydrogen and a monovalent hydrocarbon group having from 1 to 30 carbon atoms, and each subscript n independently has a value of 2 to 60;
B) the copolymer prepared in step 1), described above,
optionally C) an additional aliphatically unsaturated compound selected from the group consisting of C1) a silane, C2) an alkene, and C3) a combination hereof;
with the proviso that C) the additional aliphatically unsaturated compound is present when one polyether of formula A-1) is used as starting material A);
thereby preparing a second reaction product comprising a silicone-polyether copolymer mixture.

2. The process of claim 1, where each R is a methyl group, each D has empirical formula (C₂H₄), and subscripts x, m, and o have values such that the copolymer has 80 to 150 silicon atoms per molecule.

3. The process of claim 1, where the process further comprises one or more additional steps selected from:
adding additional hydrosilylation reaction catalyst after step 1) before and/or during step 2);
removing residual catalyst from the second reaction product after step 2); and
purifying the second reaction product after step 2).

4. The process of claim 1, where in A) the polyether, Y′ is an alkenyl group of 2 to 6 carbon atoms, each R′ is independently ethylene or propylene, X is the linking bond, and Z is hydrogen or an alkyl group of 1 to 8 carbon atoms.

5. The process of claim 1, where a combination comprising a first polyether and a second polyether is used, and in the first polyether R′ has 2 carbon atoms, and in the second polyether, R′ has 3 to 6 carbon atoms.

6. The process of claim 1, where C) the additional aliphatically unsaturated compound is present and is selected from the group consisting of:
C1) an aliphatically unsaturated trialkoxysilane of formula R¹Si(OR²)₃, where R¹ is an aliphatically unsaturated monovalent hydrocarbon group of 2 to 12 carbon atoms, and each R² is an independently selected alkyl group of 1 to 12 carbon atoms;
C2) an aliphatically unsaturated hydrocarbon of 2 to 18 carbon atoms; and
C3) a combination of both C1) and C2).

7. The process of claim 6, where the aliphatically unsaturated hydrocarbon is an alkene of 6 to 12 carbon atoms.

8. A silicone-polyether copolymer mixture prepared by the process of claim 1, where the silicone-polyether copolymer mixture comprises copolymer species of formulas: 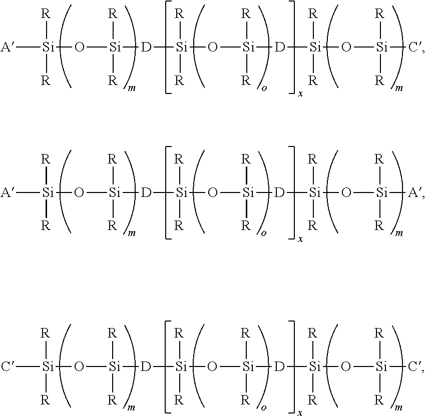
where D and R and subscripts m, o, and x are as described above, A′ is a group derived from the polyether and has formula 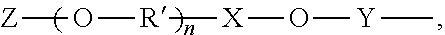
where each X is independently selected from a linking bond or a divalent hydrocarbon having from 2 to 22 carbon atoms, each R′ is independently a divalent hydrocarbon group having from 2 to 6 carbon atoms, Z is selected from hydrogen and a monovalent hydrocarbon group having from 1 to 30 carbon atoms, and each subscript n independently has a value of 2 to 60; and C′ has a formula selected from the group consisting of:
—R³Si(OR²)₃, where R³ is a divalent hydrocarbon group and R² is as described above;
—R⁴, where R⁴ is an alkyl group; and 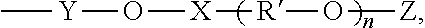
where Z, R′, X, Y, and subscript n are as described above for A′, with the proviso that at least one of Z, R′, X, Y, and subscript n differs from that of A′.

9. The copolymer mixture of claim 8, where each R is a methyl group, each D has empirical formula (C₂H₄), and subscripts x, m, and o have values such that each copolymer in the silicone-polyether copolymer mixture has 80 to 150 silicon atoms per molecule.

10. The copolymer mixture of claim 8, where each Y is an independently selected alkylene group of 2 to 6 carbon atoms, each R′ is independently ethylene or propylene, each X is the linking bond, and each Z is hydrogen or an alkyl group of 1 to 8 carbon atoms.

11. A foam control formulation comprising:
a silicone-polyether copolymer mixture comprises copolymer species of formulas: 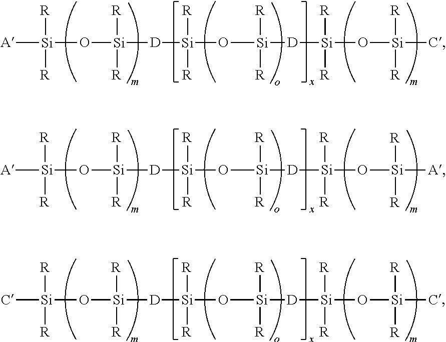
where D and R and subscripts m, o, and x are as described above, A′ is a group derived from the polyether and has formula 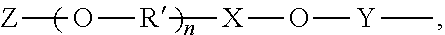
where each X is independently selected from a linking bond or a divalent hydrocarbon having from 2 to 22 carbon atoms, each R′ is independently a divalent hydrocarbon group having from 2 to 6 carbon atoms, Z is selected from hydrogen and a monovalent hydrocarbon group having from 1 to 30 carbon atoms, and each subscript n independently has a value of 2 to 60; and C′ has a formula selected from the group consisting of:
—R³Si(OR²)₃, where R³ is a divalent hydrocarbon group and R² is as described above;
—R⁴, where R⁴ is an alkyl group; and 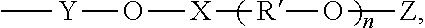
where Z, R′, X, Y, and subscript n are as described above for A′, with the proviso that at least one of Z, R′, X, Y, and subscript n differs from that of A′, and
at least one additional constituent.

12. The foam control formulation of claim 11, where the additional constituent is selected from the group consisting of a linear polydiorganosiloxane, a mineral oil, an organic solvent, a water dispersible carrier, a surface active agent, a thickening agent, water, and combinations thereof.

13.-14. (canceled)

15. The copolymer mixture of claim 9, where each Y is an independently selected alkylene group of 2 to 6 carbon atoms, each R′ is independently ethylene or propylene, each X is the linking bond, and each Z is hydrogen or an alkyl group of 1 to 8 carbon atoms.

16. The foam control formulation of claim 11, where each R is a methyl group, each D has empirical formula (C₂H₄), and subscripts x, m, and o have values such that each copolymer in the silicone-polyether copolymer mixture has 80 to 150 silicon atoms per molecule.

17. A method comprising: adding the foam control composition of claim 11 to a transparent liquid laundry detergent.

18. A method comprising: adding the foam control composition of claim 16 to a transparent liquid laundry detergent.

19. A method for controlling foam, the method comprising: adding the silicone-polyether copolymer mixture of claim 8 to a foaming liquid.

20. A method for controlling foam, the method comprising: adding the silicone-polyether copolymer mixture of claim 9 to a foaming liquid.
